(19) United States
(12) Patent Application Publication
(10) Pub. No.: US 2014/0133648 A1
(43) Pub. Date: May 15, 2014

(54) METHOD AND APPARATUS FOR ACOUSTIC ECHO CANCELLATION IN VOIP TERMINAL

(71) Applicants: Andrzej Czyzewski, Gdynia (PL); Andrzej Ciarkowski, Gdansk-Wrzeszcz (PL)

(72) Inventors: Andrzej Czyzewski, Gdynia (PL); Andrzej Ciarkowski, Gdansk-Wrzeszcz (PL)

(21) Appl. No.: 14/083,127

(22) Filed: Nov. 18, 2013

Related U.S. Application Data
(63) Continuation-in-part of application No. 12/735,941, filed on Aug. 26, 2010, now Pat. No. 8,588,404.

(30) Foreign Application Priority Data
Mar. 6, 2008 (PL) P384616

(51) Int. Cl. H04M 9/08

(52) U.S. Cl. CPC H04M 9/082
USPC 379/406.08

(57) ABSTRACT

A method of acoustic echo cancellation in the VoIP terminal using processing of the far-end signal with the digital adaptive filter in order to obtain the echo estimate that is subtracted from the microphone signal in which the far-end signal, before is is converted to the analog from and passed to the loudspeaker (4), is marked by embedding an encoded digital signature obtained from the signature generator (14) and then detection of the digital signature is performed in the signal collected by the microphone (7) and converted to digital form, depending on the result of the digital signature detection, adaptation of the digital adaptive filter (9) is resumed or stopped. A circuit for acoustic echo cancellation in VoIP terminal contains the digital adaptive filter with the control block situated between the far-end speech signal path and the near-end speech signal path, and the double-talk detector (11) that comprises the signature generator (14) connected by the signature encoder (15).

### BACKGROUND OF THE INVENTION

1. Field of the Invention

The subject of the invention is a method and a circuit for acoustic echo cancellation in VoIP terminal. The solution is intended for various types of client terminals of Internet voice communication systems, especially when the client uses a loudspeaker instead of a headset.

2. Description of Related Art Including Information under 37 CFR 1.97 and 1.98

A development of voice transmission technologies that make use of computer networks, described using a term “Voice over IP (VoIP) telephony” is a source of numerous novel hardware and software solutions for effective transmission of the speech signal in the Internet, providing good quality of the signal. The clients of the VoIP systems are encouraged to use either a dedicated terminal, resembling the traditional telephone apparatus, or a headset consisting of headphones and a microphone. In some cases, because of various reasons, the clients need to use loudspeakers which often leads to decreased quality of the conversation due to the acoustic echo effect. The acoustic echo occurs if the far-end speech signal from the loudspeaker is collected by the microphone that should only record the near-end speech. As a result, the speech signal returns to the original speaker who hears his own voice, delayed and distorted, because the microphone at the client terminal collects not only the near speech, but also the undesired, distorted echo signal. In order to eliminate this effect, various signal processing algorithms and devices are used in order to prevent the echo signal from returning to the sender, without introducing considerable transmission delay, by means of removing the echo from the signal collected by the microphone and transmitting only the desired near-end speech signal.

A number of methods and devices for acoustic echo cancellation by means of an adaptive digital filtering is known. Processing the far-end speech signal by the adaptive filter results in obtaining an echo estimate which is then subtracted from the microphone signal. The result of this operation is used for filter adaptation. After the adaptation process is finished, the echo estimate from the adaptive filter output simulates the real acoustic echo and it may be subtracted from the microphone signal, resulting in echo cancellation. In order to achieve an accurate and efficient echo cancellation using the solutions based on adaptive filters, the filter adaptation process must not performed if a double-talk occurs, i.e. the microphone connected to the client terminal collects both near-end speech and, at the same time, echo signal from the far end. This requirement is necessary in order to prevent detuning of the filter and distortion of the processed signal. A number of methods and devices for double-talk detection, differing in complexity and accuracy, is known.

One known method of adaptive acoustic echo cancellation described in U.S. Pat. No. 4,894,820 uses the double-talk detection based on additional adaptive filter for estimation of the difference between the processed and the microphone signal, by means of comparing the statistical parameters of the signal. Another known solution described in U.S. Pat. No. 6,608,897 uses a variable filter adaptation step, depending on the difference between the processed signal, after echo removal, and the microphone signal. Yet another known double-talk detection method described in U.S. Pat. No. 6,792,107, suitable for implementation in the VoIP system, is based on calculation of a correlation between the far-end signal and the microphone signal. The correlation is a measure of similarity of the signals. If the correlation is low, a double-talk may be detected. Additionally, a dynamic threshold for the detection is determined from the analysis of both signals. Similarly, the invention described in U.S. Pat. No. 6,192,126 proposes double-talk detection by means of analysis of the signal energy in several frequency bands.

In the solution disclosed in U.S. Pat. No. 4,894,820, the acoustic echo canceller includes the digital adaptive filter and the so-called Geigel double-talk detector which compares the amplitude or energy of the microphone and the far-end signal. The international application WO98/43368 describes the device for echo cancellation containing the adaptive filter in parallel connection with the double-talk detector to which two nonlinear processors are connected, together with the noise generator, delay estimator, noise power estimator and two tone switches. Another acoustic echo canceller described in patent application WO98/51066, in addition to the adaptive filter, contains at least one additional microphone, another adaptive filter and the additional filters.

Known solutions for acoustic echo cancellation that provide high accuracy are based on complex algorithms. As a consequence, the double-talk detection requires more time and delays are introduced to the signal transmission. On the contrary, other solutions that do not introduce considerable delays, do not provide satisfactory accuracy of echo cancellation.

Therefore, none of these solutions are optimal for application in VoIP terminals having limited resources.

### SUMMARY OF THE INVENTION

1. Purposes of the Invention

It is a purpose of the invention to furnish a device for improved acoustic echo cancellation in a VoIP terminal.

2. Brief Description of the Invention

A method of monitoring a sound channel with adapting corrector of the characteristics of a system of convertor-casing-environment, wherein a signal is reproduced through a loudspeaker 23 and registered through a 1.

A method of acoustic echo cancellation in the VoIP terminal as proposed in the invention in which the far-end speech signal is processed with the digital adaptive filter in order to obtain the echo estimate that is subtracted from the microphone signal, the result is used for adaptation of the digital adaptive filter and the filter adaptation process is stopped while the double-talk is present, is characterized by marking the digital far-end speech signal, before it is converted to the analog form and passed to the loudspeaker, by means of adding an encoded digital signature obtained from the signature generator, to the signal, and then a detection of the digital signature is performed in the signal collected by the microphone and converted to digital form and depending on detection of presence or absence of the digital signature in the signal, adaptation of the digital adaptive filter is resumed or stopped.

The digital signature is a sequence of bytes chosen so that the digital signature is suppressed by the near-end speech signal of the terminal user and it is preserved in the far-end speech signal distorted in the acoustic feedback path between the loudspeaker and the microphone.

It is desirable to encode the digital signature by means of adding to the signal being marked a defined number of copies of itself, each having an independently chosen amplitude and delay.

Further development of an algorithm idea for detection of simultaneous speech, described in a U.S. Pat. No. 8,588,404, is its application in a monitoring system of a local loop of an audio track. A purpose of monitoring of the local loop “speaker-microphone” is precise detection of a situation in which a signal registered by a microphone contains additional additive distortions, which interrupt work of the adaptive algorithm used to estimate characteristics of the local loop. This system finds application in all situations in which the estimation of characteristics (an impulse response) in a closed loop is conducted in a continuous, adaptive manner. Examples of application include:

1. Correction of an amplitude linearity characteristics of the system convertors-housing-environment of a mobile device for reproduction of a sound, such as a computer, a cellular phone, a music player, a radio, or a television set. Structural limitations (e.g. associated with a dimension and a shape of a housing or casing of this type of devices or apparatuses, and the fact that they are used in not perfect conditions for sound listening, cause that a sound reproduced by these devices reaches a listener in a distorted form. A source of a distortion can be both imperfection of a device, manifested, among others, by surges and limitation of the frequency band characteristics, as well as an impact of the environment, resulting in a formation of reflections, reverberations, and resonances causing changes of timbre of a sound noticeable by a listener. Also an important factor is a construction/structure of a housing or casing of a player; in view of optimization of manufacturing costs, often it is not profitable to carry out a research and improvements, in order to eliminate a different kind of mechanical couplings, vibrations and resonances of housing or casing.

Registering reproduced sound by means of a built-in or an external microphone, the device is able, to a certain extent, to estimate characteristics of distortions and compensate or reduce them by filtration of a sound by use of a filter having a reverse characteristics, or by blocking frequencies causing a resonance mechanical elements of a housing or casing and environment. For this purpose an adaptive algorithm must be used, which in a continuous manner adjusts itself to changes in the characteristics of destortions, resulting, among others, from displacement of objects in a sound field or changes in a location of the same device.

2. Correction of acoustic of a listening room, a concert hall, a stage.

Application is similar to one described above, however, in this case the adaptive and correction system is a separated device designated precisely for that purpose, or such device can be built-in in a sound system. A device used to amplify a sound in such types of structures, usually conforms to sufficient quality standards, in order to not introduce itself significant distortions, but yet an impact of an environment cannot be ignored, especially in cases of premises which are adapted ad hoc, and objects in motions, among others people located in an accounting field. Due to dispersion of listeners and their distance from a correcting device in this application it is expected first of all use of a dedicated microphone or of a set of microphones in a distance from a correcting device.

A device for acoustic echo cancellation in the VoIP terminal according to the invention containing the digital adaptive filter with the control block, situated between the far-end speech signal path and the near-end speech signal path, and the double-talk detector, is characterized by the double-talk detector containing the signature generator connected by the signature encoder to the signature embedding block that is situated between a speech decoder and a digital-to-analog converter in the far-end speech signal path. The signature generator is also connected to the signature decoder which is connected to the output of an analog-to-digital converter in the near-end speech signal path and the output of the signature decoder is connected by the decision block to the control block of the digital adaptive filter.

The invention ensures an efficient acoustic echo cancellation without introducing the significant delay to the speech signal transmission which results in a significant increase of quality of service in the speech transmission systems using computer networks.

A purpose of the correction in all described above situations is obtaining a maximum of the best reproduction of a sound independent of changing acoustic conditions. A measure to achieve this goal is a self-linearization algorithm which is based on application of an adaptive filter, which in a continuous manner estimates changes in characteristics of distortions and adjusts a reproducing system to the most precise compensation of distortions. Likewise, as in the case of the system of acoustic echo cancellation, a subject of the U.S. Pat. No. 8,588,404, a process of adaptation is sensitive to appearance of all kind of additive distortions, which are external relative to the converter-housing-environment system.

Distortions also, from a point of view of the adaptive algorithm, introduce determined changes in a spectrum of registered signals, which algorithm will attempt also compensate. This will result in determining of the adaptive algorithm from an actual characteristics and appearance of a significant error in estimation, and in effect, improper correction. To avoid such situation a system allowing detection of the additive distortions must be in place, which implementation, based on application of shipping digital signals, is a subject to be claimed by the applicant.

The use of correction to linearize audio track characteristics is not new; such idea was described in the U.S. Pat. No. 4,612,665A, relating to a graphical equalizer, enabling equalization of frequency characteristics or frequency response in a number of sub bands, in reliance on indications of a spectrum analyzer. Such correction, however, takes places manually and not in a continuous manner, and precision of a possible compensation is limited by a number of bands of a corrector which is determined at the production stage.

In the U.S. Pat. No. 4,694,498A extended the above-described idea by implementation of automatic determination of the correction characteristics by connecting a correcting device with a system generating a signal of known characteristics and its registration, and next matching or fitting characteristics of a corrector to the intended signal. Such approach, however, is not suitable for correction in continuous mode, as a measuring signal normally disturbs use of a corrector. A half-baked solution of such problem proposed in the U.S. Pat. No. 5,506,910A, which predicts a possibility of concurrent use of a corrector as a correcting device and performing measurements, however, performing measurement is only possible in specific situations, and used measuring signals can still be heard and disturb reception of useful sounds. Moreover, a correction takes place only in a specified number of sub bands.

In the Patent No. EP 1,387,487 A2 is described a system, which allows correction in a continuous mode, without introduction of additional measurement signals, however, correction takes place in a limited number of sub bands, and does not consider a system detecting disturbances, which can negatively affect results of measurement, besides it is only considered an amplitude characteristic, and a phase characteristic is omitted.

Application of an adaptive filter for correction of characteristic of converters or speakers described in the U.S. Pat. No. 5,694,476 A, however, it is a much narrower application of the filter than in the present patent application. It does not consider a system of controlling of a process of adaptation of the filter subject to the claims.

An example of the realization of the invention is illustrated by the block diagram of the VoIP terminal.

### BRIEF DESCRIPTION OF THE SEVERAL VIEWS OF THE DRAWING(S)

There is shown in:

FIG. 1 a schematic view of a preferred embodiment of the invention.

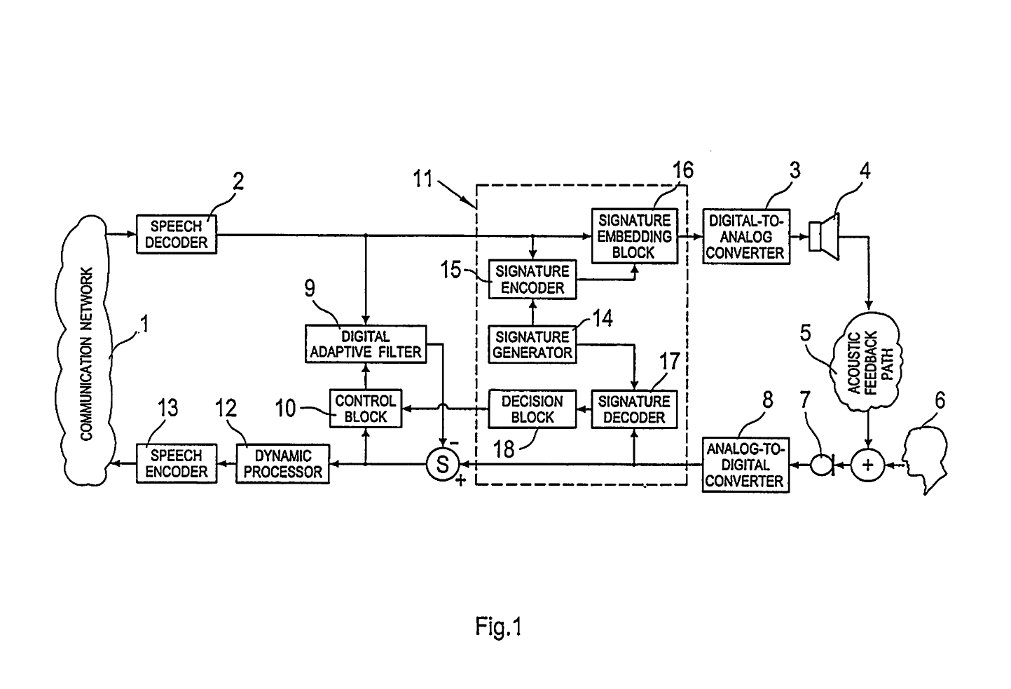

FIG. 2 shows a diagram of adapting corrections characteristic of the system of converter-casing-environment exploiting the system of monitoring of the sound channel.

### DETAILED DESCRIPTION OF THE INVENTION

A method of acoustic echo cancellation in the VoIP terminal is based on processing the far-end speech signal using the digital adaptive filter 9 in order to obtain the acoustic echo estimate which is then subtracted from the signal collected by the microphone 7 and the resulting signal is used for the adaptation of the digital adaptive filter 9.

The process of filter adaptation is stopped when the double-talk is present (signals from both the far-end speaker and the near-end speaker are present at the same time) and the double-talk is detected by the double-talk detector 11. The double-talk detection is performed as follows: a digital far-end speech signal, before it is converted to the analog form and passed to the loudspeaker 4, is marked by adding the encoded digital signature, originating from the signature generator 14, to the far-end speech signal, and then the detection of the signature in the signal collected by the microphone 7 and converted to the digital form, is performed. The digital signature is a defined sequence of bytes chosen so that the digital signature is suppressed by the near-end speech when it is present and the signature is preserved in the analog far-end speech signal distorted by the acoustic feedback path 5 between the loudspeaker 4 and the microphone 7. In order to obtain the signal that is immune to distortions, the digital signature is encoded in a way that a sum of a defined number of scaled and delayed copies of the marked signal form the signature. Therefore, the embedding of the signature in the signal is based on the echo hiding algorithm. In case the signature is not found in the signal collected by the microphone 7, the adaptation of the digital adaptive filter 9 is stopped, and when the signature is found in the signal, the adaptation of the filter is resumed.

The VoIP client terminal is connected to the communication network 1. At the input of the terminal, in the far-end signal path, a speech decoder 2 is situated, to which the digital-to-analog converter 3 and the loudspeaker 4 are connected. The acoustic feedback path 5, shown symbolically in the block diagram, causes a distortion of the acoustic waves emitted by the loudspeaker 4, that are collected by the microphone 7, together with the near-end speech from the terminal user 6. In the near-end signal path, the analog-to-digital converter 8 is connected to the microphone 7 and the output of the analog-to-digital converter 8 is connected to the summation node S to which the output of the digital adaptive filter 9 is also connected. The output of the speech decoder 2 and the output of the control block 10 are connected to the inputs of the digital adaptive filter 9. The input of the control block 10 is connected to the double-talk detector 11 and the output of the summation node S. The output of the summation node S is connected by a dynamic processor 12 and a speech encoder 13 to the input to the communication network 1.

The double-talk detector 11 contains the signature generator 14, the signature encoder IS, the signature embedding block 16, the signature decoder 17 and the decision block 18. The output of the signature generator 14 is connected by the signature encoder IS to the signature embedding block 16 which is situated between the output of the speech decoder 2, connected also to the signature encoder 15, and the input of the digital-to-analog converter 3 in the far-end speech signal path. The output of the signature generator 14 is connected also, by the signature decoder 17, to the decision block 18, output of which is connected to the control block 10 of the digital adaptive filter 9. To the signature decoder 17, the output of the analog-to-digital converter 8 in the near-end speech signal path is also connected.

The digital far-end speech signal is received from the communication network 1, decoded by the speech decoder 2, converted to the analog form by the digital-to-analog converter 3 and passed to the loudspeaker 4. The loudspeaker 4 emits the acoustic waves that are distorted in the acoustic feedback path 5, mainly due to the repetitive wave reflections that cause the reverberation effect. In case that the near-end terminal user 6 is silent, the microphone 7 collects only the distorted far-end speech signal. This signal is converted to the digital form by the analog-to-digital converter 8. In order to prevent this signal from returning to the far-end speaker, the microphone signal is processed and attenuated by the digital adaptive filter 9 and the double-talk detector II. The digital adaptive filter 9 computes the estimate of the acoustic echo which is then subtracted in the summation node S from the signal containing echo, obtained from the output of the analog-to-digital converter 8. The result of this operation is used by the control block 10 which controls the adaptation of the digital adaptive filter 9. The coefficients of the digital adaptive filter 9 are adapted by the control block 10 and, as a result, the signal from the adaptive filter output is the echo estimate that, after it is subtracted from the microphone signal in the summation node S, forms the output signal without the echo. This procedure is efficient provided that the adaptation of the digital adaptive filter 9 is stopped as soon as the near-end terminal user 6 starts speaking to the microphone 7 and the adaptation is restarted if the near-end terminal user 6 becomes silent again. If this condition is not fulfilled, the digital adaptive filter 9 is detuned which results in deterioration of the quality of the output signal. In order to detect the double-talk, the far-end speech signal obtained from the terminal input, after the signal is processed by the speech decoder 2, is marked by the signature. The signature generator 14 produces a digital signature in a form of sequence of bytes chosen so that it is later possible to detect the presence of the signature in the signal distorted during the transmission of the sound waves between the loudspeaker 4 and the microphone 7. In the signature encoder 15, the digital signature is processed so that the signature is the sum of a defined number of scaled and delayed copies of the marked signal, which results in the signature that spans a wide range of frequencies and that is immune to signal distortions. The signature obtained this way is attenuated and added to the far-end signal in the signature embedding block 16. The signal with the embedded digital signature is passed through the digital-to-analog converter 3 to the loudspeaker 4.

The signal collected by the microphone 7 is analyzed in the double-talk detector 11 in order to find whether the signature is present in the signal.

If the double-talk is not present, the microphone signal contains only the acoustic echo and the noise. Therefore, it is possible to detect the presence of the signature in this signal. On the contrary, if the double-talk from the near-end terminal user 6 is present, the digital signature in the echo signal is suppressed by the near-end speech and no presence of the signature in the microphone signal is detected. The signature decoder 17 performs pre-processing of the microphone signal, including normalization and synchronization, then detection of the signature is performed. If the signature is detected, it is compared with the signal from the signature generator 14, which was previously inserted into the far-end signal, then the decision block 18 determines whether the signature was present in the microphone signal and switches on or off the control block 10 that controls the digital adaptive filter 9. The decision block 18 provides a binary result: if no signature was detected in the microphone signal, this means that the adaptation of the digital adaptive filter 9 has to be stopped, and if the signature was detected, this means that no double-talk is present in the microphone signal, therefore the adaptation of the digital adaptive filter 9 may be continued or resumed. Regardless of the signature detection result, the acoustic echo estimate obtained from the digital adaptive filter 9, is subtracted from the microphone signal and the resulting signal is further processed by attenuating the residual echo in the dynamic processor 12, then the signal is encoded by the speech encoder 13 and passed to the communication network 1.

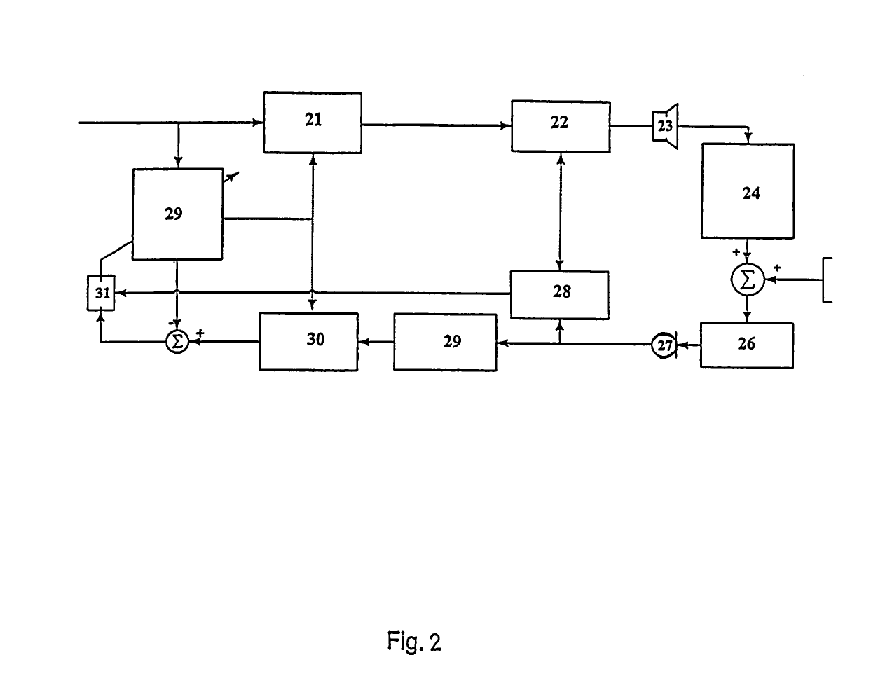

Operation of a system of correction of characteristic of a converter-casing-environment system is illustrated by a diagram shown by FIG. 2. A digital audio signal designed for reproduction is coming to an entrance of the adaptive filter 29, in which it is being used as a reference signal, constituting a basis for further calculations.

Simultaneously, it is subject of processing in a block of linearization of characteristics of track of reproduction or playback 21, which makes filtering by used of a digital filter having characteristics of reverse characteristics of channel tract of reproduction estimated using a filter 29.

Next, in the received signal is embedded a marking signature located in a block seating of the signature 22, analogously as it takes place in a system simultaneous speech detector. The signal with a seated signature is subjected analog conversion and reproduced by speaker or loudspeaker 23.

In the acoustic field the signal is subjected to changing in the time distortions of a lineal character which are result of limitation of a band signal, construction of speaker, housing or casing and environment or of a system of a converter casing environment)—4) as well as variable additional noise, the source of which is noise and additional noise (for example talk)—5) A distorted signal is registered through the microphone (27) with a measured earlier and unchanged with characteristic time (26).

The signal is registered through the microphone is subjected at the input of the block of signature detection (28), which operates identical to the algorithm case detecting language at the same time. In the case where additional perturbations (which means the signature marking was not thereby not destroyed) in the case of the signal registered through the microphone were not detected, the system of the signature detection opens the key (31) enabling the investigation of the process of filter adaptation (29). In the case where the signature cannot be kept undetected, which means that it was destroyed through additional disturbance (25), where the filter adaptation (29) is restrained.

Simultaneously with the action of the block signature detection, the signal registered through the given microphone (29) which performs the filtration with the aid of the filter with reverse characteristics to the measured characteristics of the microphone (26), thanks to which the influence of the microphone can be disregarded in the step of the estimated characteristics of the system of converter-casing-environment. In the following step, this signal is given on the input block of compensating the characteristics of linearization (30), wherein the filtration is made with the aid of characteristics reverse to the characteristics of linearization applied in block 1. Thanks to this situation, the adapting filter (9) is in the state of realizing the estimated characteristics of the system of converter-casing-environment.

This was used in the following iteration of the action of the linearizing algorithm in the blocks 21 and 30.

Contrary to other known methods and applications of audio watermarking, in the described solution only presence of the signature is detected and not the content of the signature. The expected content of the signature is already known and the detection procedure requires only determination of presence of the signature in the analyzed signal.

Therefore, the signature is chosen so that it is possible to detect its presence in a signal that was distorted by introduction of reverberations and noise in the acoustic feedback path 5 between the loudspeaker 4 and the microphone 7, and at the same time, the near-end speech from the terminal user 6 caused suppression of the signature resulting in negative result of the signature detection, which results in accurate detection of the double-talk.

1. A method of acoustic echo cancellation in a VoIP terminal in which a far-end speech signal is processed with a digital adaptive filter in order to obtain a echo estimate that is subtracted from a microphone signal and the result is used for adaptation of the digital adaptive filter, said adaptation is stopped while a double-talk is present characterized in that the far-end speech signal, before it is converted to an analog form and passed to a loudspeaker (4), is marked by adding an encoded digital signature obtained from a signature generator (14) and then detection of the digital signature is performed in a signal collected by a microphone (7) and converted to a digital form and depending on detection of presence or absence of the digital signature in the signal, adaptation of a digital adaptive filter (9) is resumed or stopped, respectively.

2. A method as in claim 1 characterized in that the digital signature is a sequence of bytes chosen so that the digital signature is suppressed by a near-end speech signal of a terminal user (6) and it is preserved in the far-end speech signal distorted in an acoustic feedback path (5) between the loudspeaker (4) and the microphone (7).

3. A method as in claim 2 characterized in that encoding of the digital signature is performed by adding to the signal a defined number of copies of itself each having an independently chosen amplitude and delay.

4. A circuit for acoustic echo cancellation in VoIP terminal containing a digital adaptive filter with a control block situated between a far-end speech signal path and a near-end speech signal path and a double-talk detector characterized in that the double-talk detector (11) comprises a signature generator (14) connected by a signature encoder (15) to a signature embedding block (16) that is situated between a speech decoder (2) and a digital-to-analog converter (3) in the far-end speech signal path, and the signature generator (14) is also connected to a signature decoder (17) which is connected to an output of the analog-to-digital converter (8) in the near-end speech signal path of a terminal user (6) and an output of the signature decoder (17) is connected by a decision block (18) to a control block (10) of a digital adaptive filter (9).

5. A method according to claim 1 further comprising monitoring a sound channel with adapting corrector of the characteristics of a system of converter-casing-environment, wherein a signal reproduced through a loudspeaker (23) and registered through a microphone (27) are subjected to adapting filtering (29) with the purpose of obtaining estimated characteristics of a system of converter-casing-environment (24), which is next used for linearization of the sound channel. The said adaptive filtration is stopped at the time of detection added to the of additional perturbations in the signal registered with the microphone, but the detection of additional disturbations is possible thanks to the application of a reproduced marking of the signal with the help of a not hearable signature, which signature is destroyed and stops from being detected in the case where an additional perturbation was added to the signal.

6. A system of an adaptive corrector with the characteristics of a system converter-casing-environment containing an adaptive filter (29) together with a steering system (31), which is controlled by a system monitoring additional perturbations lying with the seating block (22) and detection block (28) of the signature marking. The corrector uses compensating blocks with linearization characteristics (30) as well as a measurement microphone (29) with a purpose of real operation.
